(19) United States
(12) Patent Application Publication
(10) Pub. No.: US 2006/0084558 A1
(43) Pub. Date: Apr. 20, 2006

(54) Multiple holding tool

(75) Inventor: Kazuya Watanabe, Osaka-shi (JP)

Correspondence Address: HOWSON AND HOWSON;ONE SPRING HOUSE CORPORATION CENTER, BOX 457, 321 NORRISTOWN ROAD, SPRING HOUSE, PA, 19477, US

(73) Assignee: Fujicopian Co., Ltd., Osaka-shi (JP)

(21) Appl. No.: 11/242,245

(22) Filed: Oct. 3, 2005

(30) Foreign Application Priority Data
Oct. 19, 2004 (JP) JP2004-304727

(51) Int. Cl. B23Q 3/155

(52) U.S. Cl. 483/59

(57) ABSTRACT

A multiple purpose tool comprises a pair of holders, holding different media, and a generally cylindrical coupling member. Each holder has a pair of tabs on opposite sides of the medium held therein. The tabs are elastically deformable, have concave interior faces and convex exterior faces, and fit removably into recesses in opposite ends of the coupling member.

### FIELD OF THE INVENTION

This invention relates to multiple holding tools, and more particularly to improvements in multiple purpose tools in which plural holders for media, such as articles of stationery, cosmetic applicators, small tools and the like, are removably connectible to one another so that they can be carried conveniently and readily selected for use.

### BACKGROUND OF THE INVENTION

Products such as a combination coating film transfer tool and a writing implement are well known. For example, unexamined Japanese Patent Publication No. 285598/2003 discloses a combination coating film transfer tool and writing implement, in which the coating film transfer tool and the writing implement are removably coupled to one another. Unexamined Japanese Patent Publication No. 74470/2004 discloses a combination coating film transfer tool and writing implement, in which a replaceable coating film transfer tool and a writing implement are removably coupled to each other. Japanese Utility Model Registration No. 3103201 discloses a coating film transfer tool in which a plurality of replaceable coating film transfer tools are connected in series and housed in a hollow holder which can also hold a pencil, an eraser, etc. Unexamined Japanese Patent Publication No. 200885/2002 discloses a multiple holding tool in which holders containing plural pens are housed in the casing of a writing implement, in which a required pen can be selectively provided at the tip of the casing, and in which other media such as solid glue, an eraser, a lipstick, a stylus pen, etc. can also be also housed in the holders of the holding tool.

A typical multiple holding tool in which a coating film transfer tool and a writing implement are coupled to each other can only be used for writing. Other media must be provided in separate holders, and thus an individual may find it necessary to carry several kinds of holders in a pencil case or pocket. Multiple holding tools housing plural holders in a casing typically require a complicated mechanism for moving a required holder from the casing, resulting in a high cost of production.

### SUMMARY OF THE INVENTION

An object of this invention is to provide a simple multiple holding tool in which media can be readily coupled together in desired combinations, so that users can quickly select the medium they require, without searching though large numbers of separate tools and tool combinations. Other objects of the invention are to reduce the space needed to house holding tools, to provide for improved portability, and to keep production costs low.

The multiple purpose tool assembly according to the invention comprises first and second holders, and first and second media different from each other. The first and second media are connected respectively to the first and second holders, and each of said holders has a pair of tabs extending therefrom on opposite sides of the medium connected thereto. These tabs fit removably into recesses associated with the other holder, whereby the holders can be coupled to each other. Preferably, the recesses are provided in a coupling member, and the shapes of the tabs of the first holder are identical to the shapes of the tabs of the second holder, so that the first and second holders can be coupled interchangeably to the coupling member. The coupling member is preferably hollow, and at least a part of each of the first and second media is received within the coupling member.

The media may be selected from the group consisting of writing implements, adhesive applicators, erasers, correction fluid applicators, correction pens, highlighters, coating film transfer tools, cutters, and rulers, seals, stamps, lip creams, ear cleaners, miniature brushes, cases for carrying small articles, penlights; lipstick, eye pencils, eyebrow pencils, eye shadow applicators, lip liners; screw drivers, hexagon wrenches, drills; styli, and other personal computer input accessories.

The invention is particularly advantageous in embodiments in which at least one of the media is a coating film transfer tool. Moreover, both the first and second media can be coating film transfer tools different from each other, for example coating film transfer tools having films of different widths.

The invention allows a user to select plural media from among a wide variety, and to combine the same by coupling them together in a simple, multiple purpose, tool so that desired media can be made readily available to the user without the need to carry unnecessary items. A user will not need to search through a large number of tools to find a medium required for a particular purpose, nor to carry large numbers of holding tools. The invention thus reduces the space required for carrying plural media, and provides for improved portability. In addition, the invention provides a simple mechanism for coupling media directly to one another or through a coupling member, and the simplicity of the coupling mechanism results in low production cost.

In the preferred case, the shapes of the projections of the first holder are identical to the shapes of the projections of the second holder, so that the holders are interchangeable. Thus, when replacing a used medium with a new one, replacement can be accomplished easily merely by manually removing the holder containing an exhausted medium and replacing the holder containing the exhausted medium with a new holder containing a new medium.

### BRIEF DESCRIPTION OF DRAWINGS

FIG. 1 is a perspective view of a multiple purpose tool according to the invention; and

FIG. 2 is a perspective view of one of the holders of the multiple purpose tool of FIG. 1.

### DETAILED DESCRIPTION OF THE PREFERRED EMBODIMENTS

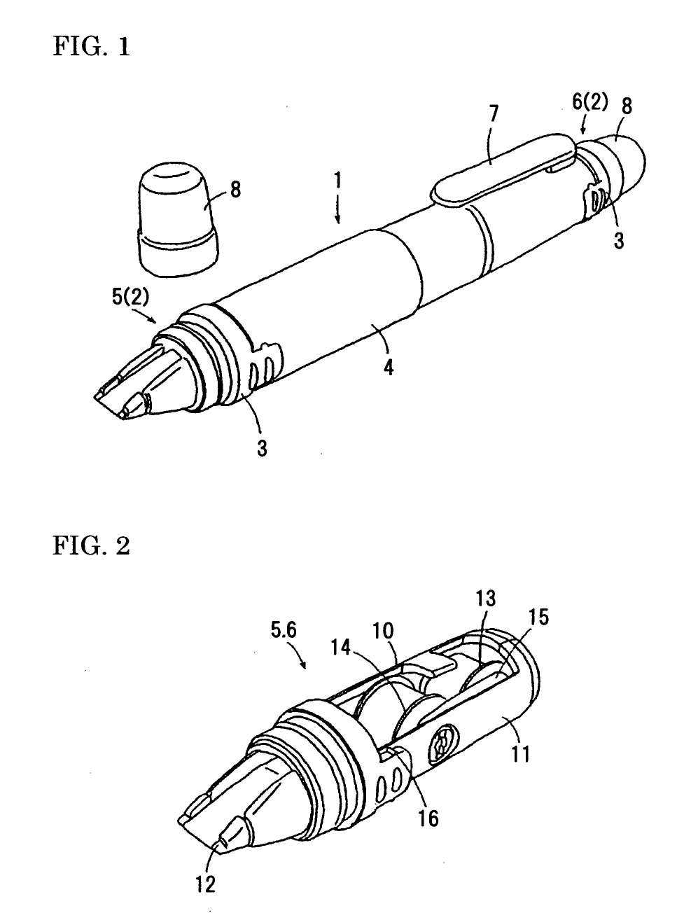

The preferred multiple holding tool comprises a coupling member having a generally cylindrical shape. As shown in FIG. 1, the coupling member 4 of multiple holding tool 1 is composed of two end cylinders of similar diameter, and an intermediate cylinder of reduced diameter. One of the end cylinders is provided with a clip 7 for clipping the tool to a chest pocket. The coupling member couples together two coating film transfer tools 5 and 6 at its opposite ends. These transfer tools have different coating films. Transfer tool 5 may have, for example, a correction tape in which the coating film has a width of 5 mm, while transfer tool 6 may have a correction tape with a film width of 3 mm.

Two recesses, in the form of generally rectangular cutouts, are provided at each end of the coupling member 4, on opposite sides of the coupling member. Each of these recesses is provided with two opposed concave notches in its edges. The transfer tools are disposed in holders 3, which have elastically deformable tabs shaped to fit into the cutouts of the coupling member. The edges of the tabs have convex projections 16 which fit into the notches in the edges of the cutouts when the tabs are fitted into the rectangular notches of the coupling member. The elastic deformation of the tabs allows the projections to fit into the notches with a snap fit, firmly securing the holders 3 to the coupling member 4, but allowing the holders to be separated manually from the coupling member for replacement. The tabs on each holder 3 preferably have convex outer surfaces and concave inner surfaces, which serve two purposes. First, the concave inner surfaces provide increased space in the holder for accommodating a coating film transfer tool or other medium. Secondly, the concave inner surfaces allow the tabs to deform more easily so that their projections 16 can slide along the edges of the rectangular cutouts as they approach the notches into which they fit.

By using one or the other of the transfer tools at opposite ends of the coupling member, a user can select either a 5 mm or 3 mm correction tape, to match the sizes of the printed matter to be corrected, and avoid transfer of correction film to adjacent printed matter that does not need to be corrected.

In an example of an alternative embodiment (not shown), a coating film transfer tool and a seal can be coupled to each other, enabling a user to correct writing mistakes, and also to affix seals to documents during a business transaction.

Preferably, the tabs of the holders for all media to be used with the coupling member have the same size and shape. Thus, any holder having a medium 2 can be connected directly to the coupling member 4. For example, a coating film transfer tool 5, having a 5 mm correction tape, can be connected to the coupling member in place of a coating film transfer tool 6, having a 3 mm correction tape. Alternatively, holders 3, holding different media 2, such as a coating film transfer tool 5 and a seal, can be coupled to one another by the coupling member 4. Holders 3, holding any type of medium 2 can be coupled to each other by the coupling member 4.

On the other hand, in another embodiment, the cutouts which serve as connecting parts at the opposite ends of the coupling member 4 can have different shapes. In this case only holders with tabs matching the cutouts at a given end of the coupling member can be connected to that end of the coupling member. Consequently, it is possible to prevent certain media from being coupled to each other.

In the preferred embodiment, each holder has two opposed tabs disposed on opposite sides of the medium held in the holder, each tab being generally rectangular and having a convex exterior face and a concave interior face, and having projections on two opposite edges. However, in alternative embodiments, one, or more than two, connecting parts can be provided on a holder, and the connecting parts can have various shapes. For example, the connecting parts of the holder can be not only in the form of the elastically deformable concavo-convex tabs as shown, but can also be in the form of flat tabs, or in the form of tabs having any of a wide variety of three-dimensional shapes. Moreover, plural tabs on a given holder can differ from one another. The connecting parts can also be composed of cooperating screw threads, hooks and cooperating holes or grooves, magnetic engagement devices, or various combination such connecting elements, so long as the holders can bee easily removed from the coupling member.

The coupling member can also be provided in a variety of shapes. For example, the coupling member can be in the shape of a disc, a sector, a sphere, or a hemisphere, and the coupling member can have any desired number of connecting parts to accommodate the connecting parts of the holder.

In the case in which one of the media is a ball point pen, a single ball point pen core can be provided in a holder, and can be replaced by another ball point pen core in a different holder. Moreover, two different ball point pen cores can be provided at opposite ends of a coupling member, and one or the other can be easily selected by the user. There is no need for a holder to have a casing for housing multiple ball point pen cores and a complicated mechanism for selectively supplying a selected core to the tip of the casing. Consequently, multiple ball point pens can be combined using the coupling, in a simple device that has relatively few parts, and can be produced at a low cost.

The media 2 can be fixed directly to a holder 3, by press-fitting, threads, fasteners or adhesive, or removably by a suitable coupling. The media can also be housed within a cartridge fixed to the holder.

By way of a specific example, as shown in FIG. 2, each of the coating film transfer tools 5 and 6 comprises a case 10 and a cover 11. The case 10 has a transfer head 12 provided at one end, the transfer head preferably having a generally triangular shape, and a tip having a cross-section in the shape of an arc of small radius. A tape supply reel 13 and a take-up reel 14 are rotatable on two shafts (not shown) extending from the case 10. The coated transfer tape extends from the supply reel, and over the tip of the transfer head to the take-up reel. As the tape is pulled from the supply reel during use, the supply reel rotates, and an endless rubber belt 15 rotates the take up reel 14 as the supply reel 13 rotates. The transfer tool is disposed in the holder between the tabs of the holder, with one of the tabs of the holder adjacent the cover 11, as shown in FIG. 2, and the opposite tab of the holder (not shown) adjacent the case 10. The concave inner surfaces of the tabs conform to convex outer surfaces of the case 10 and the cover 11.

Removable caps 8, for protecting the media 2, are shown in FIG. 1 can be provided for a multiple holding tool 1. The caps 8 can be engaged with the transfer tools by any of various known attachment methods. For example, the caps can fit frictionally onto the transfer tools, or can be attached by hinges.

In order to miniaturize the transfer tools, and reduce costs, the reels are preferably connected by an endless rubber belt 15, which may be, for example, in the form of an O-ring engaged with small diameter extensions of the reels. However, it is possible to employ gear drive mechanisms as an alternative. Although any of various materials, such as opaque resin, or even paper, may be used to form the holder, the coupling member, and parts of the medium 2, it is desirable to form the medium 2, the holder 3, and the coupling member 4 from a transparent or semitransparent resin to enable visual observation of the transfer tape or other medium 2.

Various other modifications can be made to the multiple purpose tool described above. For example, although a coupling member is preferred for most embodiments, advantage may be taken of the cooperating projections and recesses in embodiments in which the holders are connected directly to each other, with tabs of each holder extending into recesses formed in the other holder.

What is claimed is:

1. A multiple purpose tool assembly comprising:
first and second holders; and
first and second media different from each other, the first and second media being connected respectively to said first and second holders;
wherein each of said holders has a pair of tabs extending therefrom on opposite sides of the medium connected thereto, said tabs fitting removably into recesses associated with the other holder, whereby the holders can be coupled to each other.

2. A multiple purpose tool as claimed in claim 1, including a coupling member, wherein said recesses are provided in said coupling member.

3. A multiple purpose tool as claimed in claim 1, in which the shapes of the tabs of the first holder are identical to the shapes of the tabs of the second holder, whereby the first and second holders are interchangeable.

4. A multiple purpose tool as claimed in claim 2, in which the shapes of the tabs of the first holder are identical to the shapes of tabs of the second holder, whereby the first and second holders can be coupled interchangeably to said coupling member.

5. A multiple purpose tool as claimed in claim 1, wherein said media are selected from the group consisting of writing implements, adhesive applicators, erasers, correction fluid applicators, correction pens, highlighters, coating film transfer tools, cutters, and rulers, seals, stamps, lip creams, ear cleaners, miniature brushes, cases for carrying small articles, penlights; lipstick, eye pencils, eyebrow pencils, eye shadow applicators, lip liners; screw drivers, hexagon wrenches, drills; styli, and personal computer input accessories.

6. A multiple purpose tool as claimed in claim 2, wherein said media are selected from the group consisting of writing implements, adhesive applicators, erasers, correction fluid applicators, correction pens, highlighters, coating film transfer tools, cutters, and rulers, seals, stamps, lip creams, ear cleaners, miniature brushes, cases for carrying small articles, penlights; lipstick, eye pencils, eyebrow pencils, eye shadow applicators, lip liners; screw drivers, hexagon wrenches, drills; styli, and personal computer input accessories.

7. A multiple purpose tool as claimed in claim 3, wherein said media are selected from the group consisting of writing implements, adhesive applicators, erasers, correction fluid applicators, correction pens, highlighters, coating film transfer tools, cutters, and rulers, seals, stamps, lip creams, ear cleaners, miniature brushes, cases for carrying small articles, penlights; lipstick, eye pencils, eyebrow pencils, eye shadow applicators, lip liners; screw drivers, hexagon wrenches, drills; styli, and personal computer input accessories.

8. A multiple purpose tool as claimed in claim 4, wherein said media are selected from the group consisting of writing implements, adhesive applicators, erasers, correction fluid applicators, correction pens, highlighters, coating film transfer tools, cutters, and rulers, seals, stamps, lip creams, ear cleaners, miniature brushes, cases for carrying small articles, penlights; lipstick, eye pencils, eyebrow pencils, eye shadow applicators, lip liners; screw drivers, hexagon wrenches, drills; styli, and personal computer input accessories.

9. A multiple purpose tool as claimed in claim 1, wherein at least one of said media is a coating film transfer tool.

10. A multiple purpose tool as claimed in claim 2, wherein at least one of said media is a coating film transfer tool.

11. A multiple purpose tool as claimed in claim 3, wherein at least one of said media is a coating film transfer tool.

12. A multiple purpose tool as claimed in claim 4, wherein at least one of said media is a coating film transfer tool.

13. A multiple purpose tool as claimed in claim 1, wherein said first and second media are coating film transfer tools different from each other.

14. A multiple purpose tool as claimed in claim 2, wherein said first and second media are coating film transfer tools different from each other.

15. A multiple purpose tool as claimed in claim 3, wherein said first and second media are coating film transfer tools different from each other.

16. A multiple purpose tool as claimed in claim 4, wherein said first and second media are coating film transfer tools different from each other.

17. A multiple purpose tool as claimed in claim 2, in which the coupling member is hollow, and in which at least a part of each of said first and second media is received within said coupling member.

18. A multiple purpose tool as claimed in claim 6, in which the coupling member is hollow, and in which at least a part of each of said first and second media is received within said coupling member.

19. A multiple purpose tool as claimed in claim 10, in which the coupling member is hollow, and in which at least a part of each of said first and second media is received within said coupling member.

20. A multiple purpose tool as claimed in claim 14, in which the coupling member is hollow, and in which at least a part of each of said first and second media is received within said coupling member.
